(19) United States
(12) Patent Application Publication
(10) Pub. No.: US 2020/0022534 A1
(43) Pub. Date: Jan. 23, 2020

(54) CUTTING BOARD ASSEMBLY

(71) Applicant: James Robert Sheldon, JR., Laguna Niguel, CA (US)

(72) Inventor: James Robert Sheldon, JR., Laguna Niguel, CA (US)

(21) Appl. No.: 16/039,415

(22) Filed: Jul. 19, 2018

(51) Int. Cl. A47J 47/00

(52) U.S. Cl. CPC A47J 47/005

(57) ABSTRACT

A cutting board assembly for capturing fluid resulting from cutting food items includes a cutting board that has food items positioned thereon for cutting the food items. The cutting board is hollow and the cutting board has a drain to route fluid from cutting the food item into an interior of the cutting board. A pan is slidable into the cutting board to capture the fluid from the drain.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to cutting board devices and more particularly pertains to a new cutting board device for capturing fluid resulting from cutting food items.

### BRIEF SUMMARY OF THE INVENTION

An embodiment of the disclosure meets the needs presented above by generally comprising a cutting board that has food items positioned thereon for cutting the food items. The cutting board is hollow and the cutting board has a drain to route fluid from cutting the food item into an interior of the cutting board. A pan is slidable into the cutting board to capture the fluid from the drain.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a cutting board assembly according to an embodiment of the disclosure.

FIG. 2 is a bottom view of an embodiment of the disclosure.

FIG. 3 is a perspective view of an embodiment of the disclosure showing a pan being extended outwardly from a cutting board.

FIG. 4 is a front view of an embodiment of the disclosure.

FIG. 5 is a top view of an embodiment of the disclosure.

FIG. 6 is a cross sectional view taken along line 6-6 of FIG. 5 of an embodiment of the disclosure.

### DETAILED DESCRIPTION OF THE INVENTION

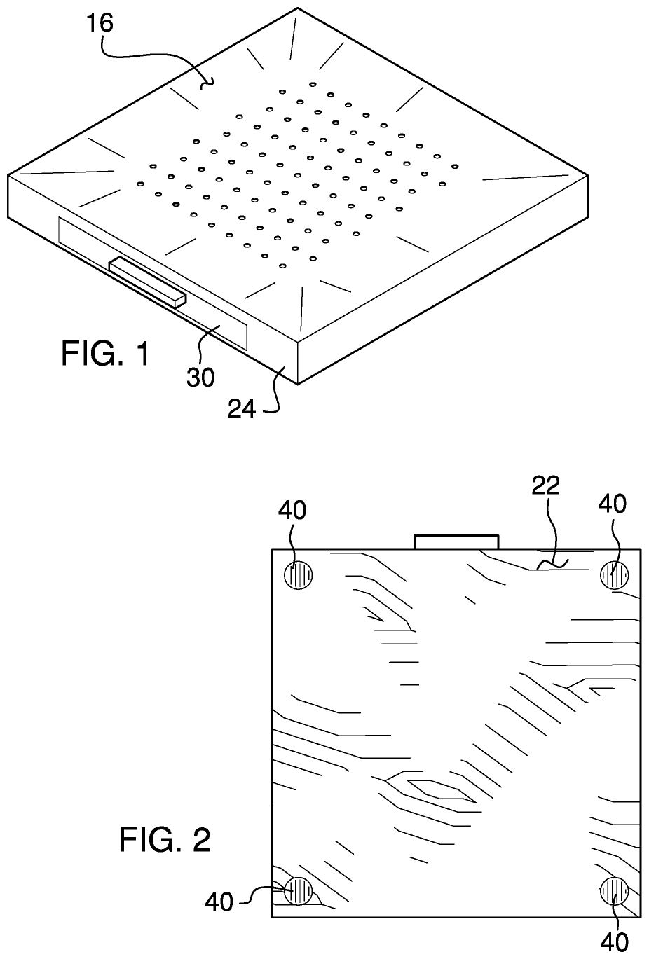

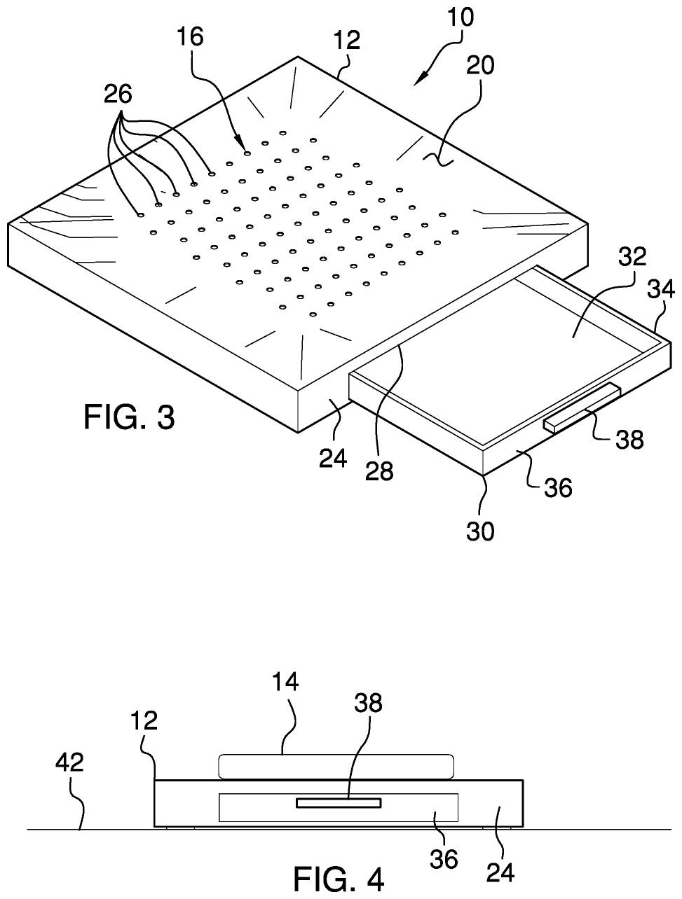

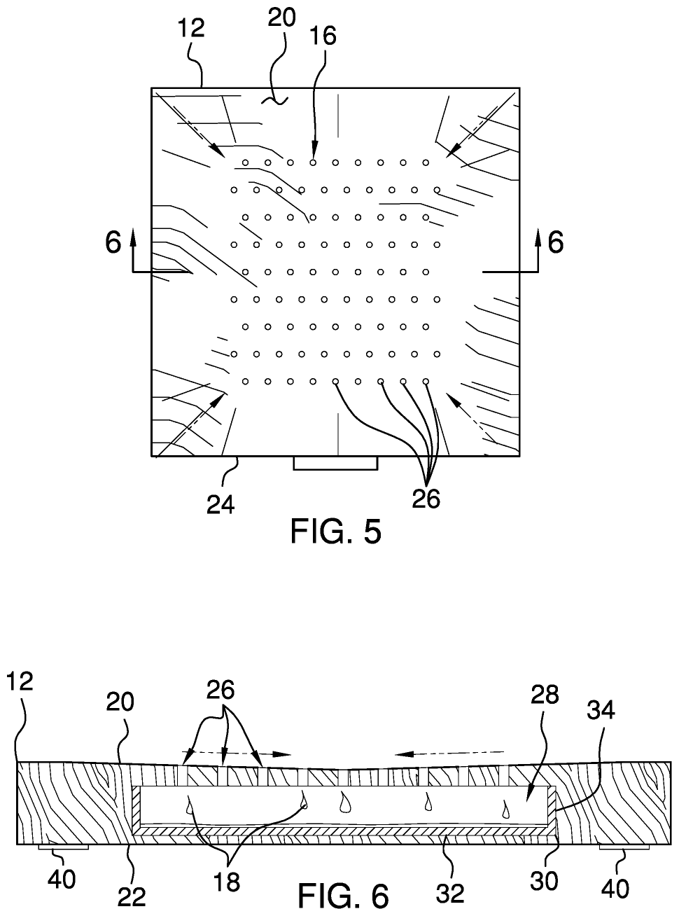

With reference now to the drawings, and in particular to FIGS. 1 through 6 thereof, a new cutting board device embodying the principles and concepts of an embodiment of the disclosure and generally designated by the reference numeral 10 will be described.

As best illustrated in FIGS. 1 through 6, the cutting board assembly 10 generally comprises a cutting board 12 that may have food items 14 positioned thereon for cutting the food items 14. The food items 14 may be meat, vegetables and any other food item commonly cut on cutting boards. The cutting board 12 is hollow and the cutting board 12 has a drain 16 therein to route fluid 18 from cutting the food items 14 into an interior of the cutting board 12. Moreover, the cutting board 12 may be comprised of a rigid material such as wood or plastic.

The cutting board 12 has a top surface 20, a bottom surface 22 and a front side 24 extending therebetween. The drain 16 comprises a plurality of apertures 26 each extending through the top surface 20 and into the interior of the cutting board 12. The front side 24 has an opening 28 extending into the interior of the cutting board 12. Moreover, the top surface 20 is concavely acruate with respect to the bottom surface 22 to inhibit the fluid 18 from spilling off of the top surface 20.

A pan 30 is slidable into the cutting board 12 to capture the fluid 18 from the drain 16. The pan 30 has a bottom wall 32 and a perimeter wall 34 extending upwardly therefrom, and the perimeter wall 34 has a forward side 36. The forward side 36 is aligned with the front side 24 of the cutting board 12 when the pan 30 is inserted into the opening 28 having the pan 30 being positioned below each of the apertures 26. A handle 38 is coupled to the forward side 36 of the pan 30 for gripping.

A plurality of feet 40 is each coupled to the bottom side of the cutting board 12. Each of the feet 40 is comprised of a resiliently compressible material such as rubber or the like. Thus, each of the feet 40 may grip a support surface 42, such as a counter top or the like, thereby inhibiting the cutting board 12 from sliding on the support surface 42. Each of the feet 40 may be aligned with a respective one of four corners of the cutting board 12.

In use, the pan 30 is slid into the cutting board 12 and the food items 14 are cut on the cutting board 12. Fluid 18 that results from cutting the food items 14, such as blood from meat or water from vegetables, passes through each of the apertures 26 to be captured in the pan 30. The pan 30 is removed from the cutting board 12 when the food items 14 are finished being cut or when the pan 30 becomes filled with fluid 18. The fluid 18 is emptied from the pan 30 and the pan 30 is either washed or reinserted into the cutting board 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cutting board assembly having a drain and a drip pan wherein said assembly is configured to capture and contain fluid dripping from food items, said assembly comprising:
a cutting board having food items positioned thereon for cutting the food items, said cutting board being hollow, said cutting board having a drain therein wherein said drain is configured to route fluid from cutting the food item into an interior of said cutting board; and
a pan being slidable into said cutting board wherein said pan is configured to capture the fluid from said drain.

2. The assembly according to claim 1, wherein:
said cutting board has a top surface, a bottom surface and a front side extending therebetween, said drain comprising a plurality of apertures extending through said top surface and into said interior of said cutting board;
said front side has an opening extending into said interior of said cutting board; and
said top surface is concavely acruate with respect to said bottom surface wherein said top surface is configured to inhibit the fluid from spilling off of said top surface.

3. The assembly according to claim 2, wherein:
said pan has a bottom wall and a perimeter wall extending upwardly therefrom, said perimeter wall having a forward side, said forward side being aligned with said front side of said cutting board when said pan is inserted into said opening having said pan being positioned below each of said apertures; and
a handle being coupled to said forward side of said pan for gripping.

4. A cutting board assembly having a drain and a drip pan wherein said assembly is configured to capture and contain fluid dripping from food items, said assembly comprising:
a cutting board having food items positioned thereon for cutting the food items, said cutting board being hollow, said cutting board having a drain therein wherein said drain is configured to route fluid from cutting the food item into an interior of said cutting board, said cutting board having a top surface, a bottom surface and a front side extending therebetween, said drain comprising a plurality of apertures extending through said top surface and into said interior of said cutting board, said front side having an opening extending into said interior of said cutting board, said top surface being concavely acruate with respect to said bottom surface wherein said top surface is configured to inhibit the fluid from spilling off of said top surface;
a pan being slidable into said cutting board wherein said pan is configured to capture the fluid from said drain, said pan having a bottom wall and a perimeter wall extending upwardly therefrom, said perimeter wall having a forward side, said forward side being aligned with said front side of said cutting board when said pan is inserted into said opening having said pan being positioned below each of said apertures;
a handle being coupled to said forward side of said pan for gripping; and
a plurality of feet, each of said feet being coupled to said bottom side of said cutting board, each of said feet being comprised of a resiliently compressible material wherein each of said feet is configured to grip a support surface thereby inhibiting said cutting board from sliding on the support surface.
